(19) United States
(12) Patent Application Publication
(10) Pub. No.: US 2011/0050654 A1
(43) Pub. Date: Mar. 3, 2011

(54) LIQUID CRYSTAL DISPLAY APPARATUS AND BACK LIGHT APPARATUS

(76) Inventors: Toshihiro Tsutsui, Inagi (JP); Hidenao Kubota, Yokohama (JP); Shigeo Ohashi, Tsuchiura (JP); Koichi Sakita, Chigasaki (JP); Katsuki Ochiai, Yokohama (JP)

(21) Appl. No.: 12/788,019

(22) Filed: May 26, 2010

(30) Foreign Application Priority Data
Aug. 31, 2009 (JP) 2009-199209

(51) Int. Cl. G06F 3/038

(52) U.S. Cl. 345/204; 345/102

(57) ABSTRACT

A backlight apparatus includes a plurality of LEDs as light-sources, a plurality of light-guiding plates, lights from the LEDs being made incident into the light-guiding plates, the incident lights being then converted into a surface-like light, and being guided onto the liquid-crystal panel side by the light-guiding plates, a plurality of LED drivers for supplying currents to the plurality of LEDs, and a plurality of LED driving boards on which the plurality of LEDs and LED drivers are implemented, wherein the plurality of LEDs are implemented on one surface of each LED driving board, and each light-guiding plate is also provided thereon, each of the LED drivers being implemented on the other surface of each LED driving board.

### INCORPORATION BY REFERENCE

The present application claims priority from Japanese application JP2009-199209 filed on Aug. 31, 2009, the content of which is hereby incorporated by reference into this application.

### BACKGROUND OF THE INVENTION

The present invention relates to a liquid-crystal display apparatus including a backlight apparatus where, for example, a plurality of light-emitting diodes (LEDs) are used as its light-sources.

From conventionally, lamps such as cold-cathode fluorescent lamp (CCFL) and external-electrode fluorescent lamp (EEFL) have been used as the light-source of a backlight apparatus for illuminating a liquid-crystal panel with light from its rear surface. In recent years, however, the use of light-emitting diodes (LEDs) as the light-source has started gradually. This is mainly because the LEDs are advantageous for the thin-shape implementation and power-saving implementation of the liquid-crystal display apparatus including the backlight apparatus. Meanwhile, each LED is a point light-source, and thus its spatial light intensity distribution is likely to become nonuniform. In view of this situation, in the backlight apparatus where the plurality of LEDs are used as its light-sources, as are disclosed in, e.g., JP-A-2001-093321, plate-like light guides (which, hereinafter, will be referred to as “light-guiding plates”) are arranged in plural number. Here, each light-guiding plate is formed of a transparent resin, and its cross-section is of the wedge-shaped configuration. The lights from the LEDs, i.e., the point light-sources, are made incident into the edge surface of each light-guiding plate on which the thickness of each light-guiding plate is large. Moreover, these lights are converted into a surface light-source by the scattering or reflection operation inside each light-guiding plate. As a result, the overall light intensity distribution is made uniform, and the liquid-crystal panel is illuminated with the resultant uniform light. Hereinafter, in some cases, the backlight apparatus like this will be referred to as “surface light-source apparatus”.

### SUMMARY OF THE INVENTION

In the LEDs-used surface light-source apparatus like this, it turns out that there mainly exist two types of heat-liberation sources. Namely, these heat-liberation sources are the plurality of LEDs, and a plurality of LED drivers which are constituted with, e.g., ICs for supplying electric currents for driving the LEDs.

In a surface light-source apparatus for illuminating a wide-area liquid-crystal panel (whose effective display area is equal to, e.g., 20 inches or more), a large number of LEDs and LED drivers become necessary. On account of this, the heat-liberation amount increases, and the temperature of the backlight apparatus or liquid-crystal display apparatus becomes a high temperature partially or entirely. It is conceivable enough that this high temperature will give rise to the occurrence of a deterioration in the optical performance of the backlight apparatus and a lowering in the safety thereof. In JP-A-2001-093321, however, no consideration is given at all to some countermeasures to address the high temperature like this of the backlight apparatus including the LEDs and LED drivers.

In view of the above-described problem, the present invention has been devised. Accordingly, its object is to provide a technology which is preferable for suppressing the high temperature of the liquid-crystal display apparatus including the LEDs-used backlight apparatus.

A backlight apparatus according to the present invention for illuminating a liquid-crystal panel with light includes a plurality of light-emitting diodes as light-sources, a plurality of light-guiding plates, the lights from the light-emitting diodes being made incident into the light-guiding plates, the incident lights being then converted into a surface-like light, and being guided onto the liquid-crystal panel side by the light-guiding plates, a plurality of LED drivers for supplying currents to the plurality of light-emitting diodes, and a plurality of LED driving boards on which the plurality of light-emitting diodes and LED drivers are implemented, wherein the plurality of light-emitting diodes are implemented on one surface of each LED driving board, and each light-guiding plate is also provided thereon, each of the LED drivers being implemented on the other surface of each LED driving board.

Each of the LED drivers, and further, a circuit element other than each LED driver may be implemented on an area other than predetermined areas which include the implementation portions of the plurality of light-emitting diodes, the area existing on the other surface of each LED driving board. Also, each LED driver implemented on the other surface of each LED driving board may be away from the implementation portions of the plurality of light-emitting diodes at a predetermined distance. Moreover, the predetermined areas on the other surface of each LED driving board and/or each of the LED drivers may be connected to a metallic chassis member via heat-liberation sheets.

According to the present invention, the LED-implemented surface and the LED-driver-implemented surface on each LED driving board are made different from each other. This configuration allows implementation of a reduction in the heat interference between the LEDs and each LED driver, both of which exhibit the large heat-liberation amounts. As a result, it becomes possible to suppress the high temperature of the apparatus. Also, on each LED driving board, each LED driver is implemented on the surface that is on the opposite side to the surface on which each light-guiding plate is installed. This configuration makes it possible to preferably implement the protection of each light-guiding plate from the heat.

### BRIEF DESCRIPTION OF THE DRAWINGS

FIG. 1 is a developed perspective view of a liquid-crystal display apparatus according to a first embodiment of the present invention;

FIG. 2 is a diagram for illustrating the parts deployment configuration of the first embodiment of the present invention;

FIG. 3 is a block diagram for illustrating the LED control by each LED driver 107;

FIG. 4A and FIG. 4B are diagrams where each LED driving board 102 according to the first embodiment is seen from its front-surface side and rear-surface side; and

FIG. 5 is a diagram where each LED driving board 160 according to a second embodiment is seen from its rear-surface side.

### DETAILED DESCRIPTION OF THE INVENTION

Hereinafter, referring to the drawings, the explanation will be given below concerning embodiments of the present invention. Incidentally, in the explanation in the respective drawings, one and the same reference numeral will be allocated to configuration elements which have a function common thereto. Moreover, the overlapped explanation will be omitted regarding the configuration elements having the common function.

### Embodiment 1

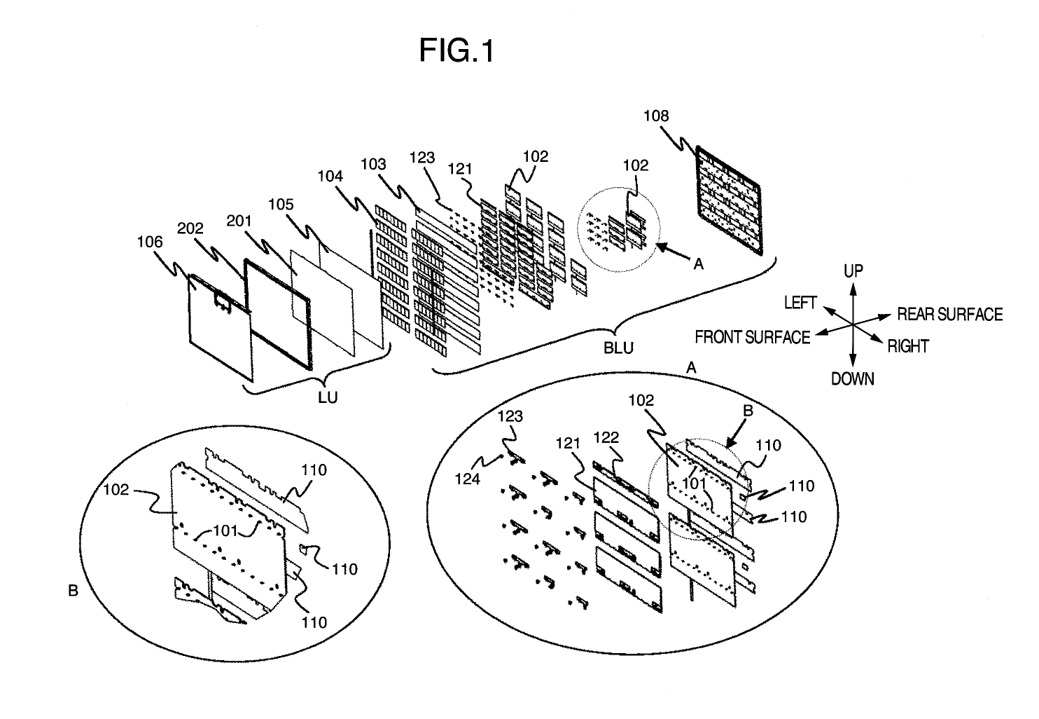

FIG. 1 is a configuration diagram of a liquid-crystal display apparatus including a backlight apparatus where LEDs (: light-emitting diodes) are used as its primary light-sources (i.e., light-sources which supply lights first). FIG. 1 illustrates a developed perspective view of the liquid-crystal display apparatus where its respective parts are developed. As illustrated in FIG. 1, the liquid-crystal display apparatus according to the present embodiment includes a liquid-crystal panel unit LU including a liquid-crystal panel 106, and the backlight apparatus BLU. First, the explanation will be given below concerning the backlight apparatus BLU.

The backlight apparatus BLU includes light-guiding plates 104, reflection sheets 103, fixing members 123, supporting members 121, LED driving boards 102, and a base chassis 108. In FIG. 1, for easiness of the illustration, partial members of the fixing members 123, the supporting members 121, and the LED driving boards 102 are illustrated on a plane that is different from the plane on which the other members are illustrated. Simultaneously, these partial members are surrounded by a circle A, and its enlarged view is illustrated at the lower-right corner of the diagram. Also, the enlarged view of a portion surrounded by a circle B is illustrated at the lower-left corner thereof.

As illustrated in each enlarged view, the plurality of LEDs 101, i.e., the primary light-sources, are implemented on each LED driving board 102 such that the LEDs 101 are arranged side by side in the right-to-left direction thereon. Here, each LED driving board 102 is used for supplying currents to the LEDs 101 thereby to drive the LEDs 101. Each LED driving board 102 is mounted with mounting hardware 122 onto the base chassis 108 which is formed of a metal, e.g., aluminum. Incidentally, in the present embodiment, each LED 101 is the side-view type LED which emits light in a direction horizontal to the electrode surface. Accordingly, in the embodiment illustrated in FIG. 1, the light from each LED 101 is emitted in the downward direction in parallel to the surface of each LED driving board 102. The emitted lights from the plurality of LEDs 101 are made incident into the light-guiding plates 104, then being converted into a surface-like light by the light-guiding plates 104. Moreover, the resultant surface-like light is outputted toward the front-surface side (i.e., side of the liquid-crystal panel 106).

Here, in the present embodiment, each light-guiding plate 104 is of the rectangular shape where each light-guiding plate 104 is horizontally longer in the right-to-left direction (i.e., horizontal direction) in FIG. 1. These light-guiding plates 104 are arranged such that the two plates are arranged in the right-to-left direction and the eight plates are arranged in the up-and-down direction (i.e., vertical direction). Moreover, as illustrated in FIG. 1, e.g., grooves extending in the up-and-down direction are formed in each light-guiding plate 104. These grooves divide each light-guiding plate 104 into eight parts in the right-to-left direction. Accordingly, in the present embodiment, the light-emitting surface of the backlight apparatus BLU is divided into areas whose number is equal to 2×8×8=128. Furthermore, each LED 101 arranged in correspondence with each area is individually controlled in response to an inputted image signal. This control allows the light intensity to be independently adjusted on each area basis in response to the image. On account of this independent adjustment, it becomes possible to enhance the contrast of the displayed mage on the liquid-crystal panel 106, and to reduce the power consumption. This is made possible by, e.g., weakening the light intensity of the area corresponding to a dark portion of the image, and strengthening the light intensity of the area corresponding to a bright portion of the image. Incidentally, hereinafter, the above-described areas obtained by dividing each light-guiding plate 104 will be referred to as “light-guiding plate blocks 104′”.

The reflection sheets 103 are arranged on the rear-surface side of the light-guiding plates 104. The reflection sheets 103 are used for allowing the emitted lights, which are made incident into the light-guiding plates 104 from the LEDs 101, to be reflected effectively onto the front-surface side. Each reflection sheet 103 and each light-guiding plate 104 are installed on the LED-implemented surface of each LED driving board 102 via each supporting member 121. Each supporting member 121 is fixed onto each LED driving board 102 by each fixing member 123 and screws 124. Also, as will be described later, each LED driver for supplying currents to drive the LEDs is implemented on the surface that is on the opposite side to the LED-implemented surface of each LED driving board 102. The area opposed to the LED-implemented portion and each LED driver on the surface on the opposite side are connected to the base chassis 108 via heat-liberation sheets 110.

Subsequently, the explanation will be given below regarding the liquid-crystal panel unit LU. As illustrated in FIG. 1, the liquid-crystal panel unit LU includes a diffusion plate 105, an optical sheet 201, and a mold frame 202. The diffusion plate 105 has a function of diffusing the emitted surface-like light outputted from the light-guiding plates 104 toward the front-surface side. This diffusion is performed in order to illuminate the entire surface of the liquid-crystal panel 106 with the emitted surface-like light which is converted into a uniform light. The optical sheet 201 has a role of enhancing the luminance of the emitted light outputted from the diffusion plate 105. The diffusion plate 105 and the optical sheet 201 are fixed onto the liquid-crystal panel 106 or the base chassis 108, using the mold frame 202.

Incidentally, in the above-described embodiment, the diffusion plate 105 and the optical sheet 201 are not included within the configuration elements of the backlight apparatus BLU. Naturally, however, the diffusion plate 105 and the optical sheet 201 may be included within the configuration elements of the backlight apparatus BLU. Also, although not illustrated in FIG. 1, an image processing circuit, a control circuit, and a power-supply circuit for supplying the power-supply to the image processing circuit and the control circuit are installed on the rear-surface side of the base chassis 108. Moreover, a rear-surface cover is provided on the rear-surface side of these circuits such that it covers these circuits.

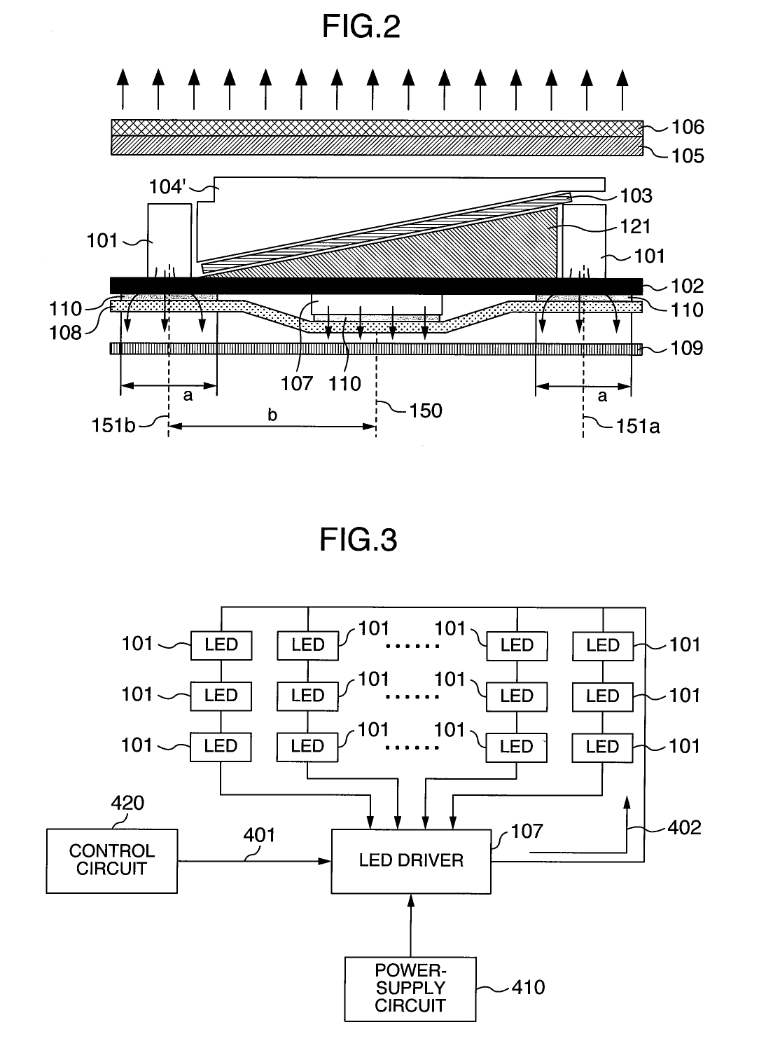

FIG. 2 is a diagram for illustrating the partial cross-section configuration (whose viewpoint is the one from the side direction of the liquid-crystal display apparatus in FIG. 1) in the up-and-down direction of the liquid-crystal display apparatus in FIG. 1. Hereinafter, referring to FIG. 2, the detailed explanation will be given below concerning the configuration and operation of the backlight apparatus according to the present embodiment.

In FIG. 2, the plurality of LEDs 101, i.e., the primary light-sources, are implemented on one surface (i.e., surface on the side of the liquid-crystal panel 106) of each LED driving board 102. Here, the LEDs used as the LEDs 101 are the kind of ones that emit, e.g., white light. Each light-guiding plate block 104′ for guiding the emitted lights from the LEDs 101 onto the front-surface side (i.e., side of the liquid-crystal panel 106) is deployed on the light-emitting side of the LEDs 101. Also, each reflection sheet 103 is provided on the rear-surface side (i.e., side of the base chassis 108) of each light-guiding plate block 104′. Each reflection sheet 103 is used for allowing the emitted lights, which are made incident into each light-guiding plate block 104′ from the LEDs 101, to be reflected effectively onto the front-surface side. Also, each supporting member 121, whose color is made white for the reflection of the emitted lights, is deployed in the space between each reflection sheet 103 and each LED driving board 102. The existence of each supporting member 121 supports each reflection sheet 103 and each light-guiding plate block 104′ from their rear-surface side.

The cross-section of each light-guiding plate block 104′ (light-guiding plate 104) in the vertical direction of the liquid-crystal panel 106 (i.e., up-and-down direction in FIG. 1) forms the wedge-shaped configuration. The wedge-shaped configuration means that, as illustrated in FIG. 2, the thickness of each light-guiding plate block 104′ becomes gradually thinner from the incident-edge surface to the front-edge portion which is opposed to the incident-edge surface. Moreover, each reflection sheet 103 is provided on the rear-surface side (i.e., side of the base chassis 108) of each light-guiding plate block 104′ (light-guiding plate 104). On account of this structure, the emitted lights, which are made incident into each light-guiding plate block 104′ from the LEDs 101, are deflected inside each light-guiding plate block 104′into the upward direction (i.e., direction onto the side of the liquid-crystal panel 106) due to the wedge-shaped configuration of each light-guiding plate block 104′ and the reflection operation of each reflection sheet 103. Furthermore, on account of the operation of a diffusion reflection pattern, the deflected lights are emitted into the upward direction (i.e., direction onto the side of the liquid-crystal panel 106) as the surface-like light whose incident-light luminance level is substantially uniform. Here, the diffusion reflection pattern is provided on the bottom surface (i.e., surface on the side of each reflection sheet 103) or the light-emitting surface (i.e., surface on the side of the liquid-crystal panel 106) of each light-guiding plate block 104′.

The diffusion plate 105 diffuses the surface-like light emitted from the light-guiding plate blocks 104′, thereby converting the surface-like light further into the surface-like light which is spatially uniform. Then, the diffusion plate 105 emits this spatially-uniform surface-like light onto the liquid-crystal panel 106. Based on an inputted image signal, the liquid-crystal panel 106 spatially modulates the surface-like light from the diffusion plate 105 on each pixel basis, thereby forming the image. On account of this, the image light, which is denoted by an arrow directed into the upward direction on the paper surface in the drawing, is outputted onto the front-surface side of the liquid-crystal display apparatus.

In this embodiment, the LEDs that emit white light have been used as the LEDs 101. The present invention, however, is not limited thereto. Namely, for example, a combination of the three LEDs, which emit three-color lights of red, blue, and green respectively, is prepared, and a plurality of these combinations may be used.

Meanwhile, each LED driver 107 is implemented on the other surface (i.e., surface on the side of the base chassis 108) of each LED driving board 102. Each LED driving board 102 is mounted onto the base chassis 108. This base chassis 108 is formed of a metal such as, e.g., aluminum, which is superior in the electrical conductivity, thermal conductivity, and mechanical strength. Also, a board on which the not-illustrated power-supply circuit and control circuit are installed is provided on the rear-surface side of the base chassis 108. Moreover, the rear-surface cover 109, which constitutes the housing, is deployed on the rear-surface side of the board.

Each LED driver 107 supplies the driving currents to the plurality of LEDs 101 implemented on the one surface of each LED driving board 102, thereby driving and controlling the LEDs 101. This operation by each LED driver 107 is performed based on the power-supply from the power-supply circuit and a control signal from the control circuit (not illustrated in FIG. 2), which are mounted on the rear-surface side of the base chassis 108. Hereinafter, referring to a block diagram illustrated in FIG. 3, the explanation will be given below regarding the driving/control operation of the LEDs 101 by each LED driver 107.

In the embodiment illustrated in the block diagram in FIG. 3, each LED driver 107 includes, e.g., eight output ports for outputting the driving currents to the LEDs 101. The respective driving currents from the respective output ports are made controllable individually. Moreover, a LED series circuit, where, e.g., the three LEDs 101 are connected in series, is connected to each output port. Namely, one output port is capable of driving/controlling one set (i.e., three units) of the LEDs. Accordingly, each LED driver 107 as a whole is capable of driving/controlling eight sets (i.e., twenty-four units) of the LEDs. Also, each LED series circuit described above, which is constituted with the three units of LEDs 101, is provided in correspondence with each light-guiding plate block 104′ described above. Consequently, the use of each LED driver 107 according to the present embodiment makes it possible to individually control intensities of the emitted surface-like lights from the eight light-guiding plate blocks 104′.

The power-supply is supplied to each LED driver 107 of the above-described configuration from the power-supply circuit 410. Moreover, the control signal 401 for adjusting such factors as the brightness of the emitted light from each LED 101 is inputted into each LED driver 107 from the control circuit 420, which is constituted with, e.g., a microprocessor. Based on an image signal inputted into the liquid-crystal display apparatus, this control signal 401 is generated by the control circuit 420. For example, the control circuit 420 divides a one-frame image signal into the areas (e.g., 128 areas) corresponding to the above-described light-guiding plate blocks 104′. Next, the circuit 420 calculates the maximum luminance level and/or average luminance level of the image signal on each area. Furthermore, in accordance with the maximum luminance level and/or average luminance level of the image signal calculated on each area, the circuit 420 determines the driving-current level to be supplied to the LED series circuit of the light-guiding plate block 104′ corresponding to each area (i.e., level of the driving current to be outputted from one output port). Namely, for example, if the maximum luminance level on a certain area is low, the circuit 420 lowers the driving-current level to be supplied to the LED series circuit of the light-guiding plate block 104′ corresponding to this area. Meanwhile, if the maximum luminance level on a certain area is high, the circuit 420 heightens the driving-current level to be supplied to the LED series circuit of the light-guiding plate block 104′ corresponding to this area. In addition, the control circuit 420 calculates the control signal 401 for setting the driving current from each output port of each LED driver 107 at the above-described driving-current level determined. Finally, the circuit 420 outputs the calculated control signal 401 to each LED driver 107. Incidentally, each LED driver 107 performs, e.g., the PWM control over the LEDs 101. Namely, a LED 101 is controlled as follows: When lowering the driving-current level to the LED 101, the duty of the driving current 402 is made smaller; whereas, when heightening the driving-current level thereto, the duty of the driving current 402 is made larger.

Based on this control signal 401 inputted, each LED driver 107 outputs the driving current 402 for driving the LEDs 101 belonging to the LED series circuit of the light-guiding plate block 104′ on each area. The driving current 402 outputted from each LED driver 107 is supplied to the LEDs 101, thereby allowing the LEDs 101 to emit the lights. On account of this, the following operation is made possible on each area: When displaying a dark image, the intensity of the emitted surface-like light from the corresponding light-guiding plate block 104′ is lowered. Meanwhile, when displaying a bright image, the intensity of the emitted surface-like light from the corresponding light-guiding plate block 104′ is heightened. After this operation, the driving current 402 outputted from the LEDs 101 is fed back to each LED driver 107, then being inputted therein.

Here, the feature configuration of the present embodiment is as follows: Each LED driving board 102 is formed into the multilayered structure where the various parts are made implementable on both surfaces of each LED driving board 102. Namely, the plurality of LEDs 101 are implemented on one surface of each LED driving board 102. Simultaneously, each light-guiding plate 104 and each reflection sheet 103 are deployed thereon. Moreover, each LED driver 107 and electrical parts such as capacitor and coil are implemented on the other surface that is on the opposite side to the one surface of each LED driving board 102 on which the LEDs 101 are implemented. Hereinafter, the one surface of each LED driving board 102 on which the LEDs 101 are implemented will be referred to as “LED-implemented surface”. Also, the other surface thereof on which each LED driver 107 and the other electrical parts are implemented will be referred to as “parts-implemented surface”. Hereinafter, the explanation will be given below concerning the reason why the deployment configuration like this is employed in the present embodiment.

As having been described earlier, the LEDs 101 and each LED driver 107 exhibit the large heat-liberation amounts. Here, the explanation will be given below regarding the heat-liberation from each LED driver 107. The per-LED heat-liberation amount at the time when a 120-mA current is flown through one LED 101 is set at 0.4 W (: watts). At this time, a 1.2-A electric current flows through each LED driver 107, and thus a 9-V voltage is applied to both ends thereof. This is because, as described above, the LED series circuit where the three LEDs 101 are connected in series is connected to one output port. Accordingly, the heat-liberation amount of each LED driver 107 in this case becomes equal to 11 W.

It is conceivable that, considering the heat-liberation from each LED driver 107 like this, the LEDs 101 and each LED driver 107 are deployed on mutually different boards in order to avoid the heat interference between the LEDs 101 and each LED driver 107. In this case, however, the boards on which the LEDs 101 and each LED driver 107 are deployed need to be connected using a wiring for transmitting the driving current 402 and the control signal 401. The existence of this wiring heightens the impedance at the time when the driving current 402 is inputted into the LEDs 101 from each LED driver 107. As a result, there is a possibility that the radiation of electromagnetic waves is caused to occur from the wiring toward the outside. Also, there is a danger that noise from the outside intrudes into the wiring, and that the waveform of the driving current 402 is deformed by the noise. Consequently, the deployment of the LEDs 101 and each LED driver 107 on the mutually different boards is disadvantageous from the aspects of cost, EMI(Electro Magnetic Interference), and noise.

On the other hand, in the case where the LEDs 101 and each LED driver 107 are deployed on one and the same board, it becomes possible not to use the wiring between the boards, and to decrease the number of the boards. Accordingly, this deployment becomes advantageous from the aspects of cost, EMI (Electro Magnetic Interference), and noise. From these reasons, it is desirable that the LEDs 101 and each LED driver 107 be deployed on one and the same board.

At this time, if both of the LEDs 101 and each LED driver 107 are implemented on one and the same surface of the same board, there is a possibility that the heat interference occurs between the LEDs 101 and each LED driver 107, and that the high temperature of both devices becomes unavoidable. Also, it becomes difficult to accomplish the heat-liberation of the heats which are generated from the LEDs 101 and each LED driver 107.

Also, as illustrated in FIG. 2, each light-guiding plate 104 and each reflection sheet 103 are deployed on the LED-implemented surface of each LED driving board 102. Accordingly, it turns out that, when both of each LED driver 107 and the LEDs 101 are implemented on the LED-implemented surface, each LED driver 107 is deployed within a space (i.e., the space where each supporting member 121 is deployed in FIG. 2) which is hermetically sealed by the LEDs 101, each LED driving board 102, and each reflection sheet 103. Consequently, it becomes difficult to accomplish the heat-liberation from each LED driver 107. Also, if the comparatively-tall electrical parts other than each LED driver 107, such as the capacitor and coil, are implemented within the above-described space, these electrical parts and each reflection sheet 103 are brought into contact with each other physically. As a result, there is a possibility that each reflection sheet 103 and further, each light-guiding plate 104 are damaged, and that there occurs deterioration in the optical characteristics of these optical parts.

Accordingly, in the present embodiment, as described earlier, in order to prevent the heat interference between each LED driver 107 and the LEDs 101, and the physical contacts between each LED driver 107 and the other electrical parts and each reflection sheet 103, and to facilitate the heat-liberation from each LED driver 107, the one surface of each LED driving board 102 is defined and set as the LED-implemented surface; whereas the other surface of each LED driving board 102 is defined and set as the parts-implemented surface. Moreover, the plurality of LEDs 101 are implemented on the LED-implemented surface, and each light-guiding plate 104 (i.e., each light-guiding plate block 104′) and each reflection sheet 103 are also installed thereon. Meanwhile, each LED driver 107 and the other electrical parts are implemented on the parts-implemented surface. This configuration makes it possible to prevent the heat interference between each LED driver 107 and the LEDs 101, and the physical contracts between each LED driver 107 and the other electrical parts and each reflection sheet 103, and further, to facilitate the heat-liberation from each LED driver 107.

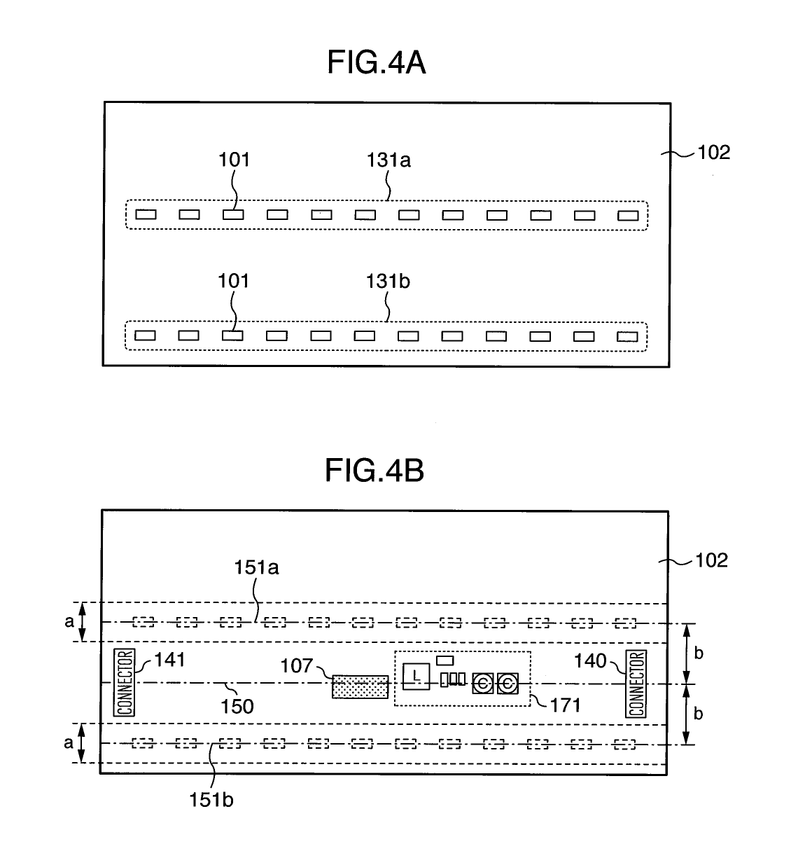

Here, referring to FIG. 2 and FIGS. 4A and 4B, the explanation will be given below regarding the details of the implementation position of each LED driver 107 on the parts-implemented surface of each LED driving board 102. FIG. 4A is a diagram where the LED-implemented surface of each LED driving board 102 illustrated in FIG. 2 is seen from the front-surface side. Also, FIG. 4B is a diagram where the parts-implemented surface of each LED driving board 102 is seen from the rear-surface side.

As illustrated in FIG. 4A, two LED strings are implemented on the LED-implemented surface of each LED driving board 102 according to the present embodiment. Here, each of the two LED strings is configured by arranging the plurality of LEDs 101 in the longitudinal direction (which corresponds to the right-to-left direction in FIG. 1) of each LED driving board 102. Also, here, the LED string positioned upward on the paper surface is defined as a first LED string 131a, and the LED string positioned downward on the paper surface is defined as a second LED string 131b. Moreover, it is assumed that the respective LED strings 131a and 131b emit the lights into the upward direction on the paper surface.

The first LED string 131a supplies the lights to the light-guiding plate 104 (not illustrated in FIGS. 4A and 4B) which is deployed on the light-emitting side (i.e., upward side on the paper surface) of the line 131 a. The second LED string 131b supplies the lights to another light-guiding plate 104 (not illustrated in FIGS. 4A and 4B) which is deployed on the light-emitting side of the line 131b. Namely, each LED driving board 102 according to the present embodiment is configured such that the one unit of LED driving board 102 supplies the lights to the two pieces of light-guiding plates 104.

Meanwhile, as illustrated in FIG. 4B, each LED driver 107 and the electrical parts 171, such as the capacitor, coil, and resistance element, are implemented between the first LED string 131a and the second LED string 131b on the parts-implemented surface of each LED driving board 102 according to the present embodiment. Furthermore, a connector 140 for transmitting the power-supply and the control signal 401 to each LED driver 107, and a connector 141 for transmitting the power-supply and the control signal 401 to the subsequent-stage LED driving board 102 are implemented therebetween on the parts-implemented surface. Here, a cable connected to the power-supply circuit 410 (refer to FIG. 3) and the control circuit 420 (refer to FIG. 3) or the preceding-stage LED driving board 102 is plugged into the connector 140. Also, a cable connected to the subsequent-stage LED driving board 102 is plugged into the connector 141.

Here, as illustrated in FIG. 2 and FIG. 4B, on the parts-implemented surface of each LED driving board 102, there are portions (i.e., portions indicated by dotted-line rectangles in FIG. 4B) which are directly below the LEDs 101 implemented on the LED-implemented surface. Then, the areas including these portions on the parts-implemented surface are defined as predetermined areas a on which the respective types of parts such as each LED driver 107, the electrical parts 171, the connectors 140 and 141 are not implemented. Also, each LED driver 107 is implemented such that each LED driver 107 is away from centers of the LED strings 131a and 131b at a predetermined distance b. Hereinafter, the explanation will be given below concerning the predetermined areas a and the predetermined distance b.

As described above, the predetermined areas a are the areas on which the respective types of parts are not implemented. The magnitude of width of these areas a is determined depending on the heat-liberation amount of each LED 101 and the mutual implementation spacing (i.e., pitch) between the adjacent LEDs 101 in each LED string. For example, in a case where the per-LED heat-liberation amount at the time when a 120-mA current is flown through one LED 101 is set at 0.4 W, and where the pitch between the adjacent LEDs 101 is set at 19.5 mm, the width of the predetermined areas a is set at a distance of, e.g., 10 mm to 15 mm. This distance is a one which is long enough to prevent the adjacent LEDs 101 from exerting influences of the heats on each other.

Also, the predetermined distance b is the distance between the implementation portions of the LEDs 101 and the implementation portion of each LED driver 107. This predetermined distance b is determined depending on such factors as the heat-liberation amount of each LED 101 and the heat-liberation amount of each LED driver 107. In the case where the per-LED heat-liberation amount at the time when the 120-mA current is flown through one LED 101 is set at 0.4 W, and the LED series circuit where the three units of LEDs 101 are connected in series is used, the 1.2-A electric current flows through each LED driver 107, and thus the 9-V voltage is applied to both ends thereof. On account of this, the heat-liberation amount of each LED driver 107 becomes equal to 11 W. In this case, when, as illustrated in FIG. 4A and FIG. 4B, the plurality of LED strings are implemented on the one piece of LED driving board 102, the predetermined distance b is set at a distance which is long enough to prevent the respective LEDs 101 and each LED driver 107 from exerting the influences on each other through the heat-liberations therefrom. Concretely, each LED driver 107 is deployed such that each LED driver 107 includes an intermediate line 150 which is positioned at an intermediate position between a central line 151a of the first LED string 131a in the LED-deployment direction and a central line 151b of the second LED string 131b in the LED-deployment direction. Namely, on the parts-implemented surface of each LED driving board 102, each LED driver 107 is implemented at the position which is away from the centers of the LED strings 131a and 131b at the predetermined distance b in a direction perpendicular to the LED-deployment direction of the LED strings. The length of this predetermined distance b is set at, e.g., about 20 mm to 200 mm.

In this embodiment, the explanation has been given regarding the case where the two LED strings are implemented on the LED-implemented surface of each LED driving board 102. The present invention, however, remains basically the same regarding a case as well where only one LED string is implemented. In this case, each LED driver 107 is implemented at a position which is away from the center of the one LED string at the predetermined distance b (e.g., 20 mm to 200 mm).

In this way, on the parts-implemented surface of each LED driving board 102, the implementation portions of the LEDs 101 and the implementation portion of each LED driver 107 are away from each other at the predetermined distance b. This configuration allows implementation of a reduction in the mutual heat interference between the LEDs 101 and each LED driver. As a result, it becomes possible to suppress the high temperature of the LEDs 101 and each LED driver.

Also, in the present embodiment, as illustrated in FIG. 2, the thermal-conductivity-property adhesive agents or adhesive sheets (which, hereinafter, will be referred to as “heat-liberation sheets”) 110 are provided on the areas (which correspond to the above-described predetermined areas a) including the rear surface of the implementation portions of the LEDs 101, and a package unit of each LED driver 107 on the parts-implemented surface of each LED driving board 102. Each LED driver 107 and the parts-implemented surface of each LED driving board 102 and the base chassis 108 are connected to each other via the heat-liberation sheets 110. On account of this configuration, the heats generated from the LEDs 101 and each LED driver 107 can be liberated by being conducted to the base chassis 108 via the heat-liberation sheets 110. The arrows directed into the downward direction on the paper surface in

FIG. 2 indicate a manner in which the heats generated from the LEDs 101 and each LED driver 107 are liberated via the heat-liberation sheets 110 and the base chassis 108.

Also, the predetermined areas a on which the parts are not implemented are provided on the parts-implemented surface of each LED driving board 102. This configuration makes it possible to provide a heat-liberation-use board wiring pattern on the predetermined areas a. On account of this configuration, the heats generated from the LEDs 101 are diffused into this heat-liberation-use board wiring pattern. Moreover, the diffused heats can be liberated by being conducted to the base chassis 108 via the rear surface of the implementation portions of the LEDs 101 and the heat-liberation sheets 110.

As having been described so far, according to the present embodiment, the plurality of LEDs 101, i.e., the primary light-sources, are implemented on the one surface of each LED driving board 102, and each light-guiding plate 104 and each reflection sheet 103 are also installed thereon. Meanwhile, each LED driver 107 for supplying the driving current 402 to the LEDs 101 and the other electrical parts 171 are implemented on the other surface of each LED driving board 102. This configuration allows implementation of a reduction in the cost, and implementation of the prevention of the mutual heat interference between the LEDs 101 and each LED driver 107, thereby making it possible to suppress the high temperature of these parts. Also, each LED driver 107, i.e., the heat-liberation part, is implemented on the other surface that is on the opposite side to the one surface on which each light-guiding plate 104 and each reflection sheet 103 are installed. This configuration makes it possible to implement the protection of each light-guiding plate 104 and each reflection sheet 103 from the heats generated from the LEDs 101, and to prevent the physical contacts between each LED driver 107 and the electrical parts and 171 and each light-guiding plate 104 and each reflection sheet 103. Furthermore, the deployment of the parts like this makes it possible to facilitate the combination of each LED driving board 102 and each light-guiding plate 104. At this time, on the parts-implemented surface of each LED driving board 102, each LED driver 107 is made away at the predetermined distance b from the portions corresponding to the implementation portions of the LEDs 101. This configuration allows implementation of the more appropriate suppression of the mutual heat interference between the LEDs 101 and each LED driver 107.

Also, on the parts-implemented surface of each LED driving board 102, the predetermined areas a on which the parts are not implemented are provided on the portions corresponding to the implementation portions of the LEDs 101. This configuration allows these areas to be utilized as the areas for liberating the heats generated from the LEDs 101. For example, the heat-liberation-use board wiring pattern is provided on these predetermined areas a, then being connected to the metallic base chassis 108 via the heat-liberation sheets 110. On account of this configuration, the heats generated from the LEDs 101 can be liberated by being conducted to the base chassis 108 via the heat-liberation-use board wiring pattern and the heat-liberation sheets 110.

Incidentally, the configuration of the backlight apparatus according to the present embodiment described so far is also applicable to a directly-below-type backlight apparatus.

### Embodiment 2

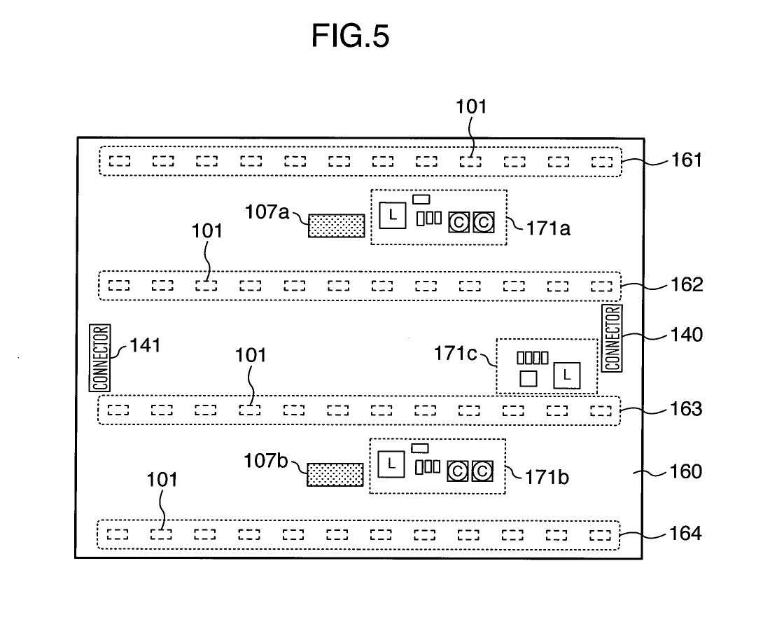

Next, referring to FIG. 5, the explanation will be given below concerning a second embodiment of the present invention. FIG. 5 is a diagram where the parts-implemented surface of each LED driving board 160 according to the second embodiment is seen from the rear-surface side. In this second embodiment, as illustrated in FIG. 5, four LED strings (: 161 to 164), each of which is configured by arranging the plurality of LEDs 101, are provided on each LED driving board 160. Consequently, the one unit of LED driving board 160 according to the present embodiment is capable of supplying the lights to the four pieces of light-guiding plates.

Here, the four LED strings 161 to 164 are implemented on the LED-implemented surface of each LED driving board 160. It is assumed that a LED group of the first LED string 161 and the second LED string 162 is driven and controlled by a first LED driver 107a, and that a LED group of the third LED string 163 and the fourth LED string 164 is driven and controlled by a second LED driver 107b.

In this case, the first LED driver 107a and electrical parts 171a connected to this first LED driver 107a are implemented between the first LED string 161 and the second LED string 162 on the parts-implemented surface of each LED driving board 160. Also, the second LED driver 107b and electrical parts 171b connected to this second LED driver 107b are implemented between the third LED string 163 and the fourth LED string 164 thereon. In this case as well, as is the case with the above-described first embodiment, the first LED driver 107a is implemented at a position which includes an intermediate line between the first LED string 161 and the second LED string 162. Also, the second LED driver 107b is implemented at a position which includes an intermediate line between the third LED string 163 and the fourth LED string 164.

Also, the connector 140, the connector 141, and further, third electrical parts 171c, which are used for such processing as power-supply filter processing, are implemented between the second LED string 162 and the third LED string 163. A cable connected to the power-supply circuit 410 (refer to FIG. 3) and the control circuit 420 (refer to FIG. 3) or the preceding-stage LED driving board 160 is plugged into the connector 140. Accordingly, the connector 140 transmits the power-supply and the control signal to the first LED driver 107a and the second LED driver 107b. A cable connected to the subsequent-stage LED driving board 160 is plugged into the connector 141. Accordingly, the connector 141 transmits the power-supply and the control signal to the subsequent-stage LED driving board 160.

In the present embodiment as well, the setting of the above-described predetermined distance b, and the heat-liberation of the LEDs 101, the first LED driver 107a, and the second LED driver 107b using the heat-liberation sheets 110 can be performed as is the case with the first embodiment.

As indicated in this second embodiment, the present invention permits the one unit of LED driving board 160 to perform the supply and control of the lights to the two or more pieces of light-guiding plates. Although, in the present embodiment, the board 160 has supplied the lights to the four pieces of light-guiding plates, the number of the pieces of the light-guiding plates may be larger than four, of course. Consequently, it is possible to supply the lights to even the six or eight pieces of light-guiding plates.

In the present embodiment, as illustrated in, e.g., FIG. 1, the plurality of LED driving boards have been used. By increasing/decreasing the size and number of these plurality of LED driving boards appropriately, it becomes possible to address and design the liquid-crystal display apparatus of various sizes (e.g., 37 inches, 47 inches, and 50 inches). Also, the dimensions or areas of all of the LED driving boards used in the liquid-crystal display apparatus need not be made equal to each other. For example, the dimensions or areas of the LED driving boards positioned at the screen's peripheral portion may be made larger or smaller than the dimensions or areas of the LED driving boards positioned at the screen's central portion.

It should be further understood by those skilled in the art that although the foregoing description has been made on embodiments of the invention, the invention is not limited thereto and various changes and modifications may be made without departing from the spirit of the invention and the scope of the appended claims.

1. A liquid-crystal display apparatus comprising a backlight apparatus for illuminating a liquid-crystal panel with light,
said backlight apparatus, comprising:
a plurality of light-emitting diodes as light-sources;
a plurality of light-guiding plates, said lights from said light-emitting diodes being made incident into said light-guiding plates, said incident lights being then converted into a surface-like light, and being guided onto said liquid-crystal panel side by said light-guiding plates;
a plurality of LED drivers for supplying currents to said plurality of light-emitting diodes; and
a plurality of LED driving boards on which said plurality of light-emitting diodes and LED drivers are implemented, wherein
said plurality of light-emitting diodes are implemented on one surface of each LED driving board, and each light-guiding plate is provided thereon,
each of said LED drivers being implemented on the other surface of each LED driving board, said other surface being a surface that is on the opposite side to said one surface on which said plurality of light-emitting diodes are implemented.

2. The liquid-crystal display apparatus according to claim 1, wherein
each of said LED drivers is implemented on an area other than predetermined areas which include said implementation portions of said plurality of light-emitting diodes, said area existing on said other surface of each LED driving board.

3. The liquid-crystal display apparatus according to claim 2, further comprising:
a metallic chassis member provided on said other-surface side of each LED driving board,
each of said LED drivers and said chassis member being connected to each other via heat-liberation sheets.

4. The liquid-crystal display apparatus according to claim 3, wherein, further,
said predetermined areas on said other surface of each LED driving board and said chassis member are connected to each other via said heat-liberation sheets.

5. The liquid-crystal display apparatus according to claim 2, wherein
a circuit element other than each of said LED drivers is implemented along with each LED driver on said area other than said predetermined areas on said other surface of each LED driving board.

6. The liquid-crystal display apparatus according to claim 2, wherein
said plurality of light-emitting diodes are arranged in a predetermined direction and in a straight-line manner on said one surface of each LED driving board,
said predetermined areas on said other surface of each LED driving board having a 10-mm to 15-mm width on cross-section of each LED driving board in a direction perpendicular to said arrangement direction of said plurality of light-emitting diodes.

7. The liquid-crystal display apparatus according to claim 1, wherein
each of said LED drivers implemented on said other surface of each LED driving board is away from said implementation portions of said light-emitting diodes at a predetermined distance.

8. The liquid-crystal display apparatus according to claim 7, wherein
said predetermined distance is equal to 20 mm to 200 mm.

9. The liquid-crystal display apparatus according to claim 1, wherein
said light-guiding plates comprise at least a first light-guiding plate and a second light-guiding plate,
a plurality of light-emitting diodes for said first light-guiding plate and a plurality of light-emitting diodes for said second light-guiding plate being arranged in a predetermined direction on said one surface of each LED driving board,
each of said LED drivers being implemented on said other surface of each LED driving board such that each LED driver includes an intermediate line between said string of said light-emitting diodes for said first light-guiding plate and said string of said light-emitting diodes for said second light-guiding plate.

10. The liquid-crystal display apparatus according to claim 1, wherein
brightness of a displayed image is made controllable on each area basis by controlling light-emitting intensities of said plurality of light-emitting diodes individually using each of said LED drivers, each of said LED drivers being implemented on said other surface of each LED driving board, said plurality of light-emitting diodes being implemented on said one surface of each LED driving board.

11. The liquid-crystal display apparatus according to claim 1, wherein
said plurality of light-guiding plates are implemented on said one surface of each LED driving board, and strings of said light-emitting diodes are implemented thereon such that said respective strings are in a one-to-one correspondence with said respective light-guiding plates, said respective strings being formed by arranging said plurality of light-emitting diodes in a predetermined direction,
each of said LED drivers implemented on said other surface of each LED driving board being designed to individually controlling light-emitting intensities of said respective strings of said light-emitting diodes, said respective strings being in said one-to-one correspondence with said respective light-guiding plates.

12. The liquid-crystal display apparatus according to claim 1, wherein
said plurality of LED driving boards are arranged on rear-surface side of said liquid-crystal panel,
dimensions or areas of said LED driving boards being made different from each other depending on arrangement positions of said LED driving boards.

13. A liquid-crystal display apparatus comprising a backlight apparatus for illuminating a liquid-crystal panel with light,
said backlight apparatus, comprising:
a plurality of light-emitting diodes as light-sources;
a plurality of LED drivers for supplying currents to said plurality of light-emitting diodes; and
a plurality of LED driving boards on which said plurality of light-emitting diodes and LED drivers are implemented, wherein
said plurality of light-emitting diodes are implemented on one surface of each LED driving board,
each of said LED drivers being implemented on the other surface of each LED driving board, said other surface being a surface that is on the opposite side to said one surface on which said plurality of light-emitting diodes are implemented.

14. A backlight apparatus for illuminating a liquid-crystal panel with light, comprising:
a plurality of light-emitting diodes as light-sources;
a plurality of light-guiding plates, lights from said light-emitting diodes being made incident into said light-guiding plates, said incident lights being then converted into a surface-like light, and being guided onto said liquid-crystal panel side by said light-guiding plates;
a plurality of LED drivers for supplying currents to said plurality of light-emitting diodes; and
a plurality of LED driving boards on which said plurality of light-emitting diodes and LED drivers are implemented, wherein
said plurality of light-emitting diodes are implemented on one surface of each LED driving board, and each light-guiding plate is provided thereon,
each of said LED drivers being implemented on the other surface of each LED driving board, said other surface being a surface that is on the opposite side to said one surface on which said plurality of light-emitting diodes are implemented.
